(19) United States
(12) Patent Application Publication
(10) Pub. No.: US 2013/0174185 A1
(43) Pub. Date: Jul. 4, 2013

(54) ELECTRONIC DEVICE

(71) Applicant: XIAO-HUI ZHOU, Shenzhen City (CN)

(72) Inventor: XIAO-HUI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/596,117

(22) Filed: Aug. 28, 2012

(30) Foreign Application Priority Data
Dec. 30, 2011 (CN) 201110454591.6

(51) Int. Cl. G11B 33/12

(52) U.S. Cl. 720/652; G9B/33.026

(57) ABSTRACT

An electronic device for reading or writing to an optical disc includes a base and a traverse module set on the base. The base defines a receiving portion for receiving the optical disc. The traverse module is used for rotating and supporting the optical disc and comprises at least one friction-reducing component. The at least one friction-reducing component protrudes out of the bottom of the receiving portion and is positioned between the optical disc and the traverse module for preventing the optical disc from rubbing against the bottom of the receiving portion.

### BACKGROUND

1. Technical Field

The present disclosure relates to electronic devices, and more particularly to a disc player.

2. Description of Related Art

In recent years, disc drives for reading/writing to optical discs such as Compact Discs (CDs), Digital Video Discs or Digital Versatile Discs (DVDs) and Mini Discs (MDs) have become more popular. The disc drives include a base defining a receiving portion for loading the optical discs and a traverse module installed on the base. However, in use, the optical disc may be tilted when the disc drives are shaken, and the optical disc may contact with the bottom of the receiving portion, and thus may be broken.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of an electronic device.

FIG. 2 is a partial, exploded view of the electronic device of FIG. 1.

FIG. 3 is an enlarged view of portion III of FIG. 1.

### DETAILED DESCRIPTION

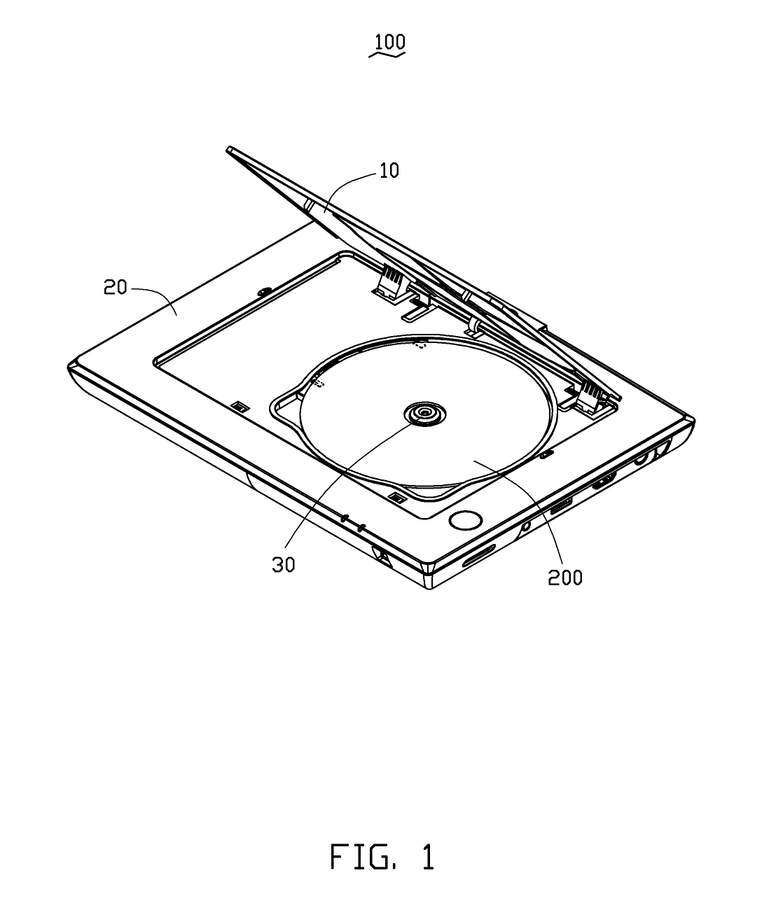

Referring to FIG. 1, an electronic device 100 of one embodiment is shown. The electronic device 100 includes a cover 10, a base 20 and a traverse module 30 set in the base 20. The electronic device 10 may be a notebook computer, a disc drive, or other electronic devices. In the embodiment, the electronic device 10 is a disc drive for reproducing information recorded on an optical disc 200.

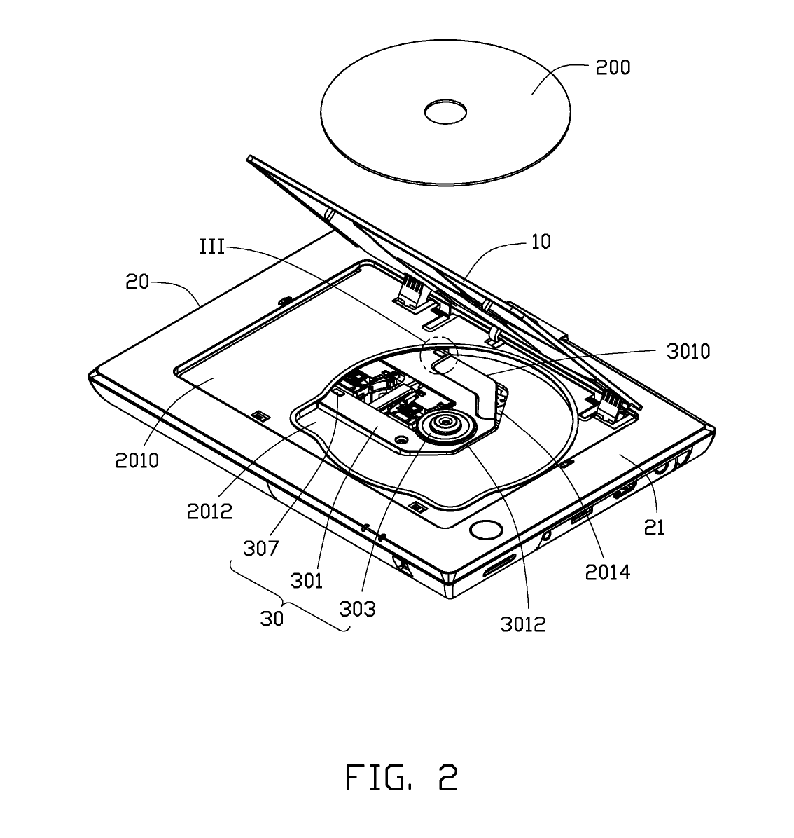

Referring to FIG. 2 also, the base 20 in the embodiment is substantially rectangle. The base 20 includes a top surface 21 and a bottom surface (not labeled) opposite to the top surface 21. The top surface 21 is recessed to define a rectangle recess 2010 for receiving the cover 10. A substantially circular receiving portion 2012 for receiving the optical disc 200 is defined in one portion of the recess 2010. The receiving portion 2012 defines an opening 2014 for mounting the traverse module 30.

The cover 10 rotatably connects to the base 20 and is capable of being opened and closed relative to the base 20. The shape of the cover 10 corresponds to the shape of the recess 2010. When the cover 10 covers on the base 20, the cover 10 is received in the recess 2010.

The traverse module 30 is set in the base 20 with a section protruding out of the bottom of the receiving portion 2012 via the opening 2014. The traverse module 30 includes a chassis 301, a spindle motor 303, and two friction-reducing components 307.

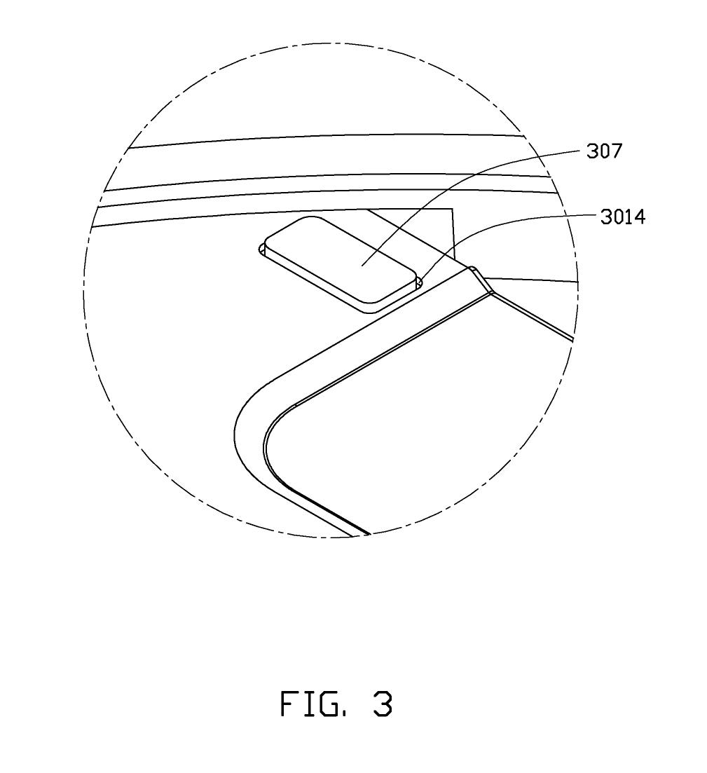

Referring to FIG. 3 also, the chassis 301 is substantially coplanar with the bottom of the receiving portion 2012. The chassis 301 includes two first rims 3010, a second rim 3012, and two concave portions 3014. The two first rims 3010 are parallel and opposite to each other. The second rim 3012 connects between the same ends exposed to the receiving portion 2012 of the two first rims 3010. The two concave portions 3014 are positioned on an end of the two first rims 3010 opposite to the second rim 3012 respectively. The two concave portions 3014 are formed on a surface of the chassis 301 opposite to the optical disc 200 and are exposed to the receiving portion 2012. In the embodiment, each concave portion 3014 is a recess.

The spindle motor 303 is secured to the chassis 301 and near the second rim 3012. The spindle motor 303 extends through the opening 2014 and protrudes out of the bottom of the receiving portion 2012, for supporting and rotating the optical disc 200. Each friction-reducing component 307 is substantially a narrow-strip, and is received in the corresponding concave portion 3014. Each friction-reducing component 307 protrudes out of the bottom of the receiving portion 2012, with a vertical height less than the vertical height of the spindle motor 303 relative to the bottom of the receiving portion 2012. When the optical disc 200 is placed on the spindle motor 303, the two friction-reducing components 307 are positioned between the chassis 301 and the optical disc 200, and keep a predetermined gap with the optical disc 200. The two friction-reducing components 307 are made of felt. In other embodiment, the two friction-reducing components 307 may be made of other soft material.

In assembly, the traverse module 30 set in the base 20 with the spindle motor 303 and the two concave portions 3014 exposed to the receiving portion 2012. The two friction-reducing components 307 are received in the corresponding concave portion 3014. The optical disc 200 is mounted on the spindle motor 303, and receives in the receiving portion 2012. The spindle motor 303 rotates the optic disc 200 for reproducing information recorded on the optic disc 200. The cover 10 rotates relative to the base 20 and is received in the recess 2010.

In use, when the optical disc 200 tilts relative to the traverse module 30, the two friction-reducing components 307 support the optical disc 200 to prevent the optical disc 200 from rubbing against the bottom of the receiving portion 2012 and protect the surface of the optical disc 200 opposite to the chassis 301.

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

What is claimed is:

1. An electronic device for reading/writing to an optical disc, comprising:
a base defining a receiving portion for receiving the optical disc, and
a traverse module set in the base for rotating and supporting the optical disc, the traverse module comprising;
at least one friction-reducing component protruding out of the bottom of the receiving portion;
wherein the at least one friction-reducing component positions between the optical disc and the bottom of the receiving portion for preventing the optical disc from rubbing against the bottom of the receiving portion.

2. The electronic device as claimed in claim 1, wherein the at least one friction-reducing component keeps a predetermined gap with the optical disc.

3. The electronic device as claimed in claim 1, wherein the traverse module comprises a chassis, the chassis is coplanar with the bottom of the receiving portion and defines at least one concave portion, and the at least one friction-reducing component is received in the corresponding concave portion.

4. The electronic device as claimed in claim 3, wherein the traverse module comprises a spindle motor secured to the chassis for supporting and rotating the optical disc, the vertical height of the at least one friction-reducing component is less than the vertical height of the spindle motor relative to the bottom of the receiving portion.

5. The electronic device as claimed in claim 1, wherein the at least one friction-reducing component is positioned between the bottom of the receiving portion and the corresponding edge of the optical disc.

6. The electronic device as claimed in claim 1, wherein the at least one friction-reducing component is made of soft material.

7. The electronic device as claimed in claim 6, wherein the at least one friction-reducing component is made of felt.
